(19) United States
(12) Patent Application Publication
(10) Pub. No.: US 2024/0158641 A1
(43) Pub. Date: May 16, 2024

(54) CARBON BLACK RECOVERY METHODS AND COMPOSITIONS COMPRISING SAME

(71) Applicant: Patrick KROEGER, Louisville, KY (US)

(72) Inventor: Patrick KROEGER, Louisville, KY (US)

(21) Appl. No.: 18/552,739

(22) PCT Filed: Mar. 31, 2022
(86) PCT No.: PCT/US2022/022729

§ 371 Date: Sep. 27, 2023

Related U.S. Application Data
(60) Provisional application No. 63/169,097, filed on Mar. 31, 2021.
(60) Provisional application No. 63/230,262, filed on Aug. 6, 2021.

(51) Int. Cl. C09C 1/48; B01D 21/26; B01D 61/14; B29B 17/02; B29K 25/00; B29K 105/00; B29K 105/24; B29K 507/04; C08K 3/04

(52) U.S. Cl. CPC C09C 1/487; B01D 21/262; B01D 61/146; B29B 17/02; C08K 3/04; B29B 2017/0224; B29B 2017/0231; B29K 2025/08; B29K 2105/0085; B29K 2105/24; B29K 2507/04; B29K 2995/0094

(57) ABSTRACT

The present technology generally relates to a method for recovering carbon black (rCB) from a vulcanized polymer matrix, the method comprising performing oxidative desulfurization of the vulcanized polymer matrix with an aqueous chloramine solution. The present technology also relates to compositions comprising rCB obtained from the methods defined herein.

### CROSS-REFERENCE TO RELATED APPLICATIONS

This application claims the benefit of and priority to U.S. provisional patent application No. 63/169,097, filed on Mar. 31, 2021; and to U.S. provisional patent application No. 63/230,262, filed on Aug. 6, 2021, the content of both of which is herein incorporated in entirety by reference.

### FIELD OF TECHNOLOGY

The present technology generally relates to methods for recovering carbon black by degrading vulcanized polymer matrix. The present technology further relates to carbon black compositions obtained by the methods defined herein.

### BACKGROUND INFORMATION

U.S. Pat. No. 9,458,303, incorporated herein by reference, describes methods of recovering devulcanized styrene butadiene rubber (SBR) from waste tire streams. PCT Application PCT/EP2020/069292, incorporated herein by reference, describes a method of processing and purification of carbonaceous materials. Styrene butadiene rubber has the highest volume production in the USA of any synthetic rubber. It is used extensively in the manufacture of automobile tires and tire-related products, as well as other products, including but not limited to sporting goods, hoses, footwear, flooring, wire and cable, raincoats, and rain boots. There is a significant need for effective recycling methods for SBR. The number of spent automobile tires discarded annually is estimated in the hundreds of millions. Hundreds of millions of tires from used automobiles are discarded annually, while the number of new automobile tires put into service each year, from new car production only, is estimated to exceed three hundred million. Besides the recovery of devulcanized polymers, recovery of silicate, zincate and carbonaceous materials can provide economic and environmental benefits for waste tire and rubber processors.

SBR is synthesized by a process known as emulsion polymerization. Polymerization of the styrene and butadiene copolymers is initialized in the aqueous phase to form a latex material at an approximate ratio of butadiene to styrene of about 3:1. The synthesized polymer then undergoes vulcanization to form sulfur cross-links, which help to impart upon the styrene butadiene base polymer the properties that are generally associated with rubber. After vulcanization, the rubber is compounded with additives which are also known to enhance properties of the rubber such as tensile strength, elongation resilience, hardness, and abrasion resistance. Table 1 presents typical compositions of SBR used for tire tread, in which PHR refers to parts per 100 parts of SBR base polymer.

TABLE 1
Typical SBR composition

| Ingredients | Per Hundred Rubber (PHR) |
|---|---|
| SBR Rubber | 100 |
| Carbon Black | 60 |
| Highly Aromatic Oil | 20 |
| Antiozonant | 1 |
| Antioxidant | 1.5 |
| Zinc Oxide | 3 |
| Stearic Acid | 1 |
| Retarder | 1 |
| Sulfur | 1.75 |
| Primary Accelerator | 1 |
| Secondary Accelerator | 0.2 |

SBR, and virtually all other vulcanized rubbers, are distinguishable from thermoplastic polymers such as polyethylene or polypropylene in that thermoplastic polymers can be melted and reused in other products, but vulcanized rubber cannot because of the interconnected network of polymer chains and sulfur cross-links formed during vulcanization. Consequently, recycling of SBR is largely limited to macroscopic, non-chemical processing of the material so it can be used in other products, such as floor mats, blasting mats, traffic cone bases or soft pavement used in athletic tracks. However, these uses only account for less than 10% of all tires discarded annually. While there are still other isolated uses for spent tires, the substantial majority of tires consumed is sent to landfills, which are not an ideal solution for such large-scale disposal. Unquestionably, with the large and continuously growing market for SBR, and the inherent challenges associated with its disposal, there is a significant need for improved methods for tire recycling.

Waste rubber often contains inorganic compounds, such as zinc oxide and silicon dioxide which reduce the performance of recovered carbon black in new rubber compound applications. Current methods of reducing inorganic content include selecting an input stream of waste rubber that contains less inorganic compounds and using air cyclone technology to separate carbon black from these inorganic compounds.

Both methods have severe limitations. Virtually all rubber compounds contain a minimum of 5-7% of inorganic material and the most widely available waste rubber, tires, usually produces carbon black with 20-30% inorganic material.

Air cyclone separation is also ineffective since carbon black, silicon dioxide, and zinc oxide produced with chloramine devulcanization have similar and often overlapping particle sizes (50-1000 nm) and these particle size similarities limit the effectiveness of the centrifugal force-based separation produced in the air cyclone.

The current state-of-the-art is to use pyrolysis to break down waste tire rubber into recovered carbon black and waste oil. This process is operated at high temperatures such as between 350° C. and 500° C. The quality of carbon black, and thus its ability to reinforce, is based on both the size of the carbon black particle and the surface activity available. Both features, but primarily surface activity, are negatively affected by exposure to the high temperature pyrolytic process. The result is that the recovered carbon black produced through pyrolytic processes is significantly less effective as a reinforcing agent than virgin carbon black.

In view of the above, there remains a need in the art for methods for recovering carbon black that alleviates at least some of the above discussed drawbacks.

### SUMMARY OF THE PRESENT TECHNOLOGY

It is an object of the present technology to ameliorate at least some of the inconveniences present in the prior art.

According to one aspect of the present technology, there is provided a method for recovering carbon black (rCB) from a vulcanized polymer matrix, the method comprising performing oxidative desulfurization of the vulcanized polymer matrix with an aqueous chloramine solution. In some instances, the vulcanized polymer matrix is a micronized vulcanized polymer matrix. In some further instances, the vulcanized copolymer matrix is a styrene-butadiene matrix. In some aspects, the method of the present technology selectively breaks sulfur crosslinks and facilitates opening up of the vulcanized polymer matrix and the release of the carbon black.

According to one aspect of the present technology, there is provided a method for recovering carbon black from micronized rubber, the method comprising: reacting the micronized rubber with an aqueous chloramine solution to obtain a first reaction mixture; separating the first reaction mixture from unreacted micronized rubber to obtain a second reaction mixture; and separating carbon black particulates from the second reaction mixture.

According to one aspect of the present technology, there is provided a carbon black composition obtained by the method as defined herein.

According to one aspect of the present technology, there is provided an elastomeric composition or rubber matrix comprising at least one carbon black obtained by the method as defined herein.

According to one aspect of the present technology, there is provided a tire or part thereof comprising the elastomeric composition or rubber matrix as defined herein.

### DETAILED DESCRIPTION

The present technology is explained in greater detail below. This description is not intended to be a detailed catalog of all the different ways in which the technology may be implemented, or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art in light of the instant disclosure which variations and additions do not depart from the present technology. Hence, the following description is intended to illustrate some particular embodiments of the technology, and not to exhaustively specify all permutations, combinations and variations thereof.

As used herein, the singular form “a,” “an” and “the” include plural referents unless the context clearly dictates otherwise.

The recitation herein of numerical ranges by endpoints is intended to include all numbers subsumed within that range (e.g., a recitation of 1 to 5 includes 1, 1.5, 2, 2.75, 3, 3.80, 4, 4.32, and 5).

The term “about” is used herein explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. For example, the term “about” in the context of a given value or range refers to a value or range that is within 20%, preferably within 15%, more preferably within 10%, more preferably within 9%, more preferably within 8%, more preferably within 7%, more preferably within 6%, and more preferably within 5% of the given value or range.

The expression “and/or” where used herein is to be taken as specific disclosure of each of the two specified features or components with or without the other. For example, “A and/or B” is to be taken as specific disclosure of each of (i) A, (ii) B and (iii) A and B, just as if each is set out individually herein.

As used herein, the term “comprise” is used in its non-limiting sense to mean that items following the word are included, but items not specifically mentioned are not excluded.

As used herein, the expression “carbon black” refers to a black finely divided form of amorphous carbon. In other words, a virtually pure elemental carbon in the form of colloidal particles. Carbon black is, for example, produced by incomplete combustion or thermal decomposition of gaseous or liquid hydrocarbons under controlled conditions. Carbon black is chemically and physically distinct from soot and black carbon. Most types of carbon black contain more than 97% of elemental carbon, said elemental carbon is generally arranged as aciniform (grape-like cluster) particulate. In the case of commercially available carbon blacks, organic contaminants such as polycyclic aromatic or polyaromatic hydrocarbons (PAHs; defined below)) are present in extremely small quantities (for example between 200-736 mg/kg depending on the grade, manufacturing method and feedstock type) and, therefore, they are not considered to be biologically available. As used herein, the expression “carbon black powder” is meant a powdery form of carbon black.

As used herein, the term “vulcanization” refers to a process of curing of elastomers, with the terms ‘vulcanization’ and ‘curing’ sometimes used interchangeably in this context. Vulcanization works by forming cross-links between sections of polymer chain which results in increased rigidity and durability, as well as other changes in the mechanical and electrical properties of the material.

As used herein, the term “micronization” refers to a process of reducing the average diameter of a solid material's particles. The term “micronized”, as used herein, refers to a solid material's particles that has been subjected to micronization. Traditional techniques for micronization focus on mechanical means, such as milling and grinding. Modern techniques make use of the properties of supercritical fluids and manipulate the principles of solubility. The term micronization usually refers to the reduction of average particle diameters to the micrometer range, but can also describe further reduction to the nanometer scale. Common applications include the production of active chemical ingredients, foodstuff ingredients, and pharmaceuticals. These chemicals need to be micronized to increase efficacy. Traditional micronization techniques are based on friction to reduce particle size. Such methods include milling, bashing and grinding. A typical industrial mill is composed of a cylindrical metallic drum that usually contains steel spheres. As the drum rotates the spheres inside collide with the particles of the solid, thus crushing them towards smaller diameters. In the case of grinding, the solid particles are formed when the grinding units of the device rub against each other while particles of the solid are trapped in between. Methods like crushing and cutting are also used for reducing particle diameter but produce more rough particles compared to the two previous techniques (and are therefore the early stages of the micronization process). Crushing employs hammer-like tools to break the solid into smaller particles by means of impact. Cutting uses sharp blades to cut the rough solid pieces into smaller ones. Modern methods use supercritical fluids in the micronization process. These methods use supercritical fluids to induce a state of supersaturation, which leads to precipitation of individual particles. The most widely applied techniques of this category include the RESS process (Rapid Expansion of Supercritical Solutions), the SAS method (Supercritical Anti-Solvent) and the PGSS method (Particles from Gas Saturated Solutions). These modern techniques allow for greater tuneability of the process. Parameters like relative pressure and temperature, solute concentration, and antisolvent to solvent ratio are varied to adjust the output to the producer's needs. The supercritical fluid methods result in finer control over particle diameters, distribution of particle size and consistency of morphology. Because of the relatively low pressure involved, many supercritical fluid methods can incorporate thermolabile materials. Modern techniques involve renewable, nonflammable and nontoxic chemicals. In the case of RESS (Rapid Expansion of Supercritical Solutions), the supercritical fluid is used to dissolve the solid material under high pressure and temperature, thus forming a homogeneous supercritical phase. Thereafter, the mixture is expanded through a nozzle to form the smaller particles. Immediately upon exiting the nozzle, rapid expansion occurs, lowering the pressure. The pressure will drop below supercritical pressure, causing the supercritical fluid—usually carbon dioxide—to return to the gas state. This phase change severely decreases the solubility of the mixture and results in precipitation of particles. The less time it takes the solution to expand and the solute to precipitate, the narrower the particle size distribution will be. Faster precipitation times also tend to result in smaller particle diameters. In the SAS method (Supercritical Anti-Solvent), the solid material is dissolved in an organic solvent. The supercritical fluid is then added as an antisolvent, which decreases the solubility of the system. As a result, particles of small diameter are formed. There are various submethods to SAS which differ in the method of introduction of the supercritical fluid into the organic solution. In the PGSS method (Particles from Gas Saturated Solutions) the solid material is melted and the supercritical fluid is dissolved in it. However, in this case the solution is forced to expand through a nozzle, and in this way nanoparticles are formed. The PGSS method has the advantage that because of the supercritical fluid, the melting point of the solid material is reduced. Therefore, the solid melts at a lower temperature than the normal melting temperature at ambient pressure.

In some embodiments, the present technology provides for a method for the recovery of carbon black from a vulcanized polymer matrix. In some instances, the vulcanized polymer matrix is a vulcanized styrene butadiene rubber (SBR) matrix. As shown in Table 1, carbon black comprises by far the largest component of compounded vulcanized SBR besides the base copolymer itself. Common methods of tire recycling involve pyrolysis, which can detrimentally change the properties of the recovered carbon black.

The present technology stems from the appreciation that the carbon black material recovered from chloramine treated waste tire carcasses and other sources is of particular high quality and that this method of carbon black recovery present advantages over existing pyrolytic methods.

In one embodiment, the method of the present technology uses an aqueous chloramine process to recover a higher-grade carbon black (rCB) from vulcanized polymer matrix such as, but not limited to, waste tires, when compared to carbon black recovered from other technologies.

As such, in some embodiments, the present technology relates to a method for recovering carbon black (rCB) from a vulcanized polymer matrix. The method comprises performing oxidative desulfurization of the vulcanized polymer matrix with an aqueous chloramine solution. In some instances, the vulcanized polymer matrix is a vulcanized SBR. In some instances, the vulcanized polymer matrix is micronized.

Aqueous chloramine devulcanizes vulcanized polymer by reacting with and breaking down sulfur crosslinks within the polymer. When this devulcanization occurs, carbon black is released from the polymer along with any silicon dioxide and zinc oxide that was included in the original polymer. These particles of carbon black, silicon dioxide, and zinc oxide, already wetted from the aqueous devulcanization process, are reacted stoichiometrically with sodium hydroxide at between about 100° C. and about 250° C., at autogenous pressure via the following reactions:

2NaOH+SiO₂→Na₂SiO₃+H₂O (1)

ZnO+2NaOH→Na₂ZnO₂+H₂O. (2)

Water-insoluble silicon dioxide and zinc oxide are converted to water soluble sodium silicate and sodium zincate. The carbon black is unaffected by the sodium hydroxide and remains insoluble in water. The newly formed aqueous solution of sodium silicate and sodium zincate is then separated from the carbon black by filtration and the carbon black is washed multiple times with substantially pure water to remove residual sodium compounds.

The sodium silicate, which is also known as water glass, is a useful product in industry and can be converted into precipitated silica.

In certain embodiments, the method of the present technology provides for the oxidative desulfurization of the vulcanized styrene-butadiene matrix comprising waste rubber streams principally derived from worn out tires. Waste tires contain approximately 30% carbon black by weight along with synthetic and natural elastomers, sulfur, and other ingredients to improve mechanical properties or increase product life. The carbon black, along with the rubber and other compounds are fixed with in the rubber matrix by sulfur crosslinks, the result the vulcanization process. In certain embodiments, the process of recovering carbon black form waste tire streams comprises reacting waste rubber with aqueous chloramine (such as, for example, monochloramine NH₂Cl).

In some embodiments, the polymer from which carbon black is recovered is sulfur vulcanized polyisoprene, latex, natural rubber, neoprene, polychloroprene, butyl rubber, nitrile rubber, halobutyl rubber, ethylene propylene diene terpolymer (EPDM). More generally, the polymer includes any that are sulfur vulcanized.

In some embodiments, the carbon black filler in the rubber is N100-N700 series.

In some instances, the waste rubber is micronized tire rubber. In some other instances, the micronized tire rubber has a particle size of less than about 500 microns. In some other instances, the micronized tire rubber has a particle size of below 1 mm. In certain embodiments, the desired particle size of the waste rubber stream may be obtained by shredding, grinding, milling, pulverizing, crushing, or any other manner of size reducing the waste rubber stream.

In some instances, the in concentrations of aqueous chloramine useful in the method of the present technology is between about 0.05 mol/L and about 1.0 mol/L, between about 0.05 mol/L and about 0.5 mol/L, or between about 0.075 mol/L and about 0.3 mol/L with the waste rubber. In some embodiments, the aqueous chloramine solutions may be prepared by reacting aqueous sodium hypochlorite with aqueous ammonia. In other embodiments, the aqueous chloramine solution may be prepared by reacting calcium hypochlorite with aqueous ammonia. The chloramine solution may be obtained by any number of methods known in the art.

In some embodiments, the aqueous chloramine solution may be prepared by reacting any aqueous solution containing a hypochlorite species with either aqueous ammonia or ammonia vapor diffused into the aqueous phase.

In some embodiments, the aqueous chloramine may be prepared by reacting an aqueous chlorine solution with an aqueous ammonium salt.

In some embodiments, the chloramine may be obtained by the gas phase reaction between ammonia and chlorine.

In yet still other embodiments, the micronized rubber may be reacted with gas phase chloramine.

In some other embodiments, additional solvents are added to the aqueous chloramine solution. The additional solvents may comprise acetone, diethyl ketone, methyl ethyl ketone, or any polar solvent.

In other embodiment, the chloramine may be synthesized in water, then extracted into another solvent. Other solvents may include diethyl ether, acetone, heptane, cyclohexane, carbon tetrachloride, methyl ethyl ketone, or any other suitable solvent for the desired waste rubber stream.

In some embodiments, the chloramine may be synthesized in the gas phase, then dissolved in a solvent. Solvents include diethyl ether, acetone, heptane, cyclohexane, carbon tetrachloride, methyl ethyl ketone, or any other suitable solvent for the desired waste rubber stream.

In some embodiments, the aqueous chloramine solution useful in the method of the present technology further comprises dichloramine. In some embodiments, the aqueous chloramine solution useful in the method of the present technology further comprises trichloramine. In some embodiments, the aqueous chloramine solution useful in the method of the present technology further comprises hypochlorite.

In some embodiments, the aqueous chloramine solution may have a pH of about 4 to about 14, or of between about 4 and 8, or of between about 5 and 8.

In some embodiments, the method further comprises heating the mixture of vulcanized polymer matrix and aqueous chloramine so as to selectively break the sulfur crosslinks, thus opening up the vulcanized polymer matrix and releasing the carbon black and other compounds into the aqueous solution.

In this process the devulcanized elastomeric compounds may also recovered.

In some instances, the heating is performed at a temperature of less than about 250° C. In some instances, the heating is performed at a temperature of less than about 200° C. In some instances, the heating is performed at a temperature of less than about 150° C. In some instances, the heating is performed at a temperature of less than about 100° C. In some instances, the heating is performed at a temperature of less than about 90° C. In some instances, the heating is performed at a temperature of less than about 75° C. In some instances, the heating is performed at a temperature of less than about 50° C. In some instances, the heating is performed at a temperature of less than about 25° C. In some instances, the heating is performed at a temperature of less than about 10° C. In some instances, the heating is performed at a temperature above about 0° C. In some instances, the heating is performed at a temperature of between about 50° C. and 100° C.

In some other embodiments, the vulcanized polymer matrix is treated with an aqueous chloramine solution comprising from about 0.001 M to about 2 M chloramine.

In still some embodiments, the chloramine treatment is performed for a time ranging between about 0.5 h and about 48 h.

In certain embodiments, the reaction between the vulcanized polymer matrix and chloramine is conducted at a pressure of at least about 10 psi, at least about 11 psi, at least about 12 psi, at least about 13 psi, or at least about 15 psi. In some instances, the reaction between the vulcanized polymer matrix and chloramine is conducted at a pressure of at least 14.69 psi.

In some embodiments, the method of the present technology further comprises collecting carbon black produced following the chloramine treatment. In some instances, the method further comprises collecting and concentrating carbon black produced following the chloramine treatment. In some instances, the carbon black is collected using membrane filtration.

In certain embodiments, the carbon black is recovered from the reaction mixture by filtration, centrifugation, straining, cycloning, flotation, skimming, or flocculation, or by a combination thereof

In some aspects, the carbon black recovered from the chloramine treatment of the present technology has one or more of the following properties: high surface area, high surface activity (when compared with other recovered carbon blacks), high absorption/adsorption potential, and high tensile strength, modulus, and abrasion resistance when compounded with rubber.

In other embodiments, the carbon black recovered with the methods of the present technology maintains at least some of the carbon black-polymer bonds formed at surface active sides during the initial vulcanization. This residual polymer can crosslink with new rubber when re-compounded and provide additional reinforcement to the rubber compound. This results in increased tensile strength, modulus, and abrasion resistance versus other recovered carbon black materials.

In some embodiments, the method of the present technology further comprises drying the carbon black recovered from the chloramine treatment. In some instances, the carbon black is dried at a temperature below about 700° C. In some instances, the carbon black is dried at a temperature below about 650° C. In some instances, the carbon black is dried at a temperature below about 600° C. In some instances, the carbon black is vacuum dried. In some instances, the carbon black is dried in an inert atmosphere. In some embodiments, the inert atmosphere comprises one or more of nitrogen, carbon dioxide and hydrogen. In yet other instances, the inert atmosphere comprises less than 20% oxygen.

In certain embodiments, the recovered carbon black is kept moist for storage.

In certain embodiments, the method of the present technology further includes sonication, microwave irradiation, shear or combinations thereof in order to accelerate the devulcanization reaction.

In certain embodiments, carbon black produced through aqueous chloramine devulcanization is in the form of a dilute slurry and may be separated from devulcanized polymer via a filtration and centrifugation system. The centrifugation system accumulates the carbon black, silicon dioxide, and zinc oxide as a dense paste which is removed by batch from a solid bowl centrifuge. The paste, still wetted, is transferred from the centrifuge bowl into a batch reactor and mixed with an aqueous solution or aqueous suspension of a source of hydroxide. In some instances, the source of hydroxide is sodium hydroxide, lithium hydroxide, ammonium hydroxide, magnesium hydroxide, calcium hydroxide, sodium carbonate, sodium bicarbonate, potassium hydroxide, or a hydroxide form of an ion exchange resin. In still other embodiments, the paste may be formed by gravitational settling.

In certain embodiments, the method of the present technology can be run continuously. Solid carbon black (with zinc and silica) can be extruded continuously via a nozzle bowl centrifuge into the reactor where the source of hydroxide is dosed at an appropriate rate and concentration to achieve the desired residence time. The output from this reactor contains the same dissolved zinc and silica material as in the batch reaction process.

In some embodiments, the hydroxide treatment step may be performed under agitation, or under the natural convective mass transfer conditions created by heating the reactor to maintain the desired process temperature.

In still other embodiments, the carbon black in the dilute slurry is concentrated, and the concentrated, wet, carbon black is subjected to the hydroxide treatment process described herein.

In still other embodiments, the concentrated, wet, carbon black is treated with a nitrogen hydride compound after being separated from the devulcanized polymer matrix. As used herein, the expression “nitrogen hydride compound” means a chemical substance having at least one nitrogen-hydrogen bond. Typical nitrogen hydride compounds include, but are not limited to ammonia, ammonium hydroxide, mono and di-substituted and unsubstituted alkyl amines. hydrazines, hydroxylamines and the like.

In other embodiments, the concentrated, wet, carbon black is treated with a nitrogen hydride compound just before, or during the hydroxide treatment process.

In other embodiments, the concentrated, wet, carbon black is not treated with a nitrogen hydride compound just before, or during the hydroxide treatment process.

In certain embodiments, the present technology provides for compositions comprising the carbon black material obtained by a process described herein. In some instances, the carbon black compositions of the present technology comprise covalently bound polymer or co-polymer residues. In some instances, the covalently bound polymer or co-polymer residues are present in the carbon black composition of the present technology with an elemental molar composition ratio of hydrogen to carbon is about 0.00001% to about 0.0001%, about 0.0001% to about 0.001%, about 0.001% to 0.01%, about 0.01% to about 0.1%, or greater than about 0.1%.

In some embodiments, the carbon black compositions of the present technology have an ash content of less than about 30%, less than about 25%, less than about 20%, less than about 15%, less than about 10%, less than about 5%, less than about 4%, less than about 3%, less than about 2%, less than about 1%, or less than about 0.5%.

In some embodiments, the composition of the present have a specific surface area (by nitrogen) of surface area of more than about 25 m²/g, more than about 30 m²/g, more than about 35 m²/g, more than about 40 m²/g, more than about 45 m²/g, more than about 50 m²/g, more than about 60 m²/g, more than about 70 m²/g, more than about 80 m²/g, more than about 90 m²/g, or more than about 100 m²/g.

In certain other embodiments, the present technology provides for compositions having an Iodine Absorption Number of more than about 10 g/kg, more than about 15 g/kg, more than about 20 g/kg, more than about 25 g/kg, more than about 30 g/kg, more than about 35 g/kg, more than about 40 g/kg, more than about 50 g/kg, more than about 60 g/kg, more than about 70 g/kg, more than about 80 g/kg, more than about 90 g/kg, more than about 100 g/kg, more than about 110 g/kg, or more than about 120 g/kg.

In certain other embodiments, the present technology provides for carbon black compositions having an oil adsorption number, tint strength, and toluene discoloration values superior than those exhibited by virgin carbon black.

In certain other embodiments, the present technology provides for carbon black compositions having an oil adsorption number, tint strength, and toluene discoloration values superior than those exhibited by pyrolytically recovered carbon black.

In certain embodiments, the present technology relates to a carbon black composition such as for example, but not limited to, an elastomeric composition or a rubber matrix (e.g., a tire), comprising the carbon black obtained with the methods of the present technology. In some embodiments, the carbon black obtained by the methods of the present technology has the ability to impart at least one mechanical property in said composition such as: i) an elongation (%) of between about 200 and about 600, or between about 250 and about 350, or about 300, according to ASTM D 3191-02; ii) a tensile strength (MPa) of between about 1 and about 30, or between about 5 and about 25, or between about 5 and about 15; iii) a drum abrasion of between about 35 ARI and about 100 ARI, of between about 40 ARI and about 75 ARI; and iv) a tear strength die B of between about 35 kN/m and about 60 kN/m, or between about 35 kN/m and about 50 kN/m.

In one or more embodiments, the present technology relates to an elastomeric composition or rubber matrix comprising a least one carbon black of the present technology and at least one elastomer. The carbon black can be used in the same proportions with respect to the elastomer that are commonly used for carbon blacks having similar morphology. One of skill in the art will recognize that the appropriate proportion will depend upon the morphology of the carbon Hack, the matrix composition, and the desired use of the filled polymer. Depending on the surface area and structure, various carbon blacks may be employed at a loading of from about 10 phr to about 100 phr, for example, about 10 phr to about 60 phr. One or more elastomers can be present, and the elastomers that can be used are conventional in the formation of elastomeric compositions, such as rubber compositions. The elastomer can be used in conventional amounts.

Any suitable elastomer may be compounded with the carbon blacks to provide the elastomeric compounds of the present technology. Such elastomers include, but are not limited to, homo- or co-polymers of 1,3 butadiene, styrene, isoprene, isobutylene, 2,3-dimethyl-1,3-butadiene, acrylonitrile, ethylene, and propylene The elastomer can have a glass transition temperature (Tg) as measured by differential scanning colorimetry (DSC) ranging from about −120″C. to about 0° C. Examples include, but are not limited, styrene-butadiene rubber (SBR), natural rubber, polybutadiene, polyisoprene, and their oil-extended derivatives. Blends of any of the foregoing may also be used.

Among the rubbers suitable for use with the present technology are natural rubber and its derivatives such as chlorinated rubber. The carbon blacks of the invention may also be used with synthetic rubbers such as: copolymers of from about 10 to about 70 percent by weight of styrene and from about 90 to about 30 percent by weight of butadiene such as copolymer of 19 parts styrene and 81 parts butadiene, a copolymer of 30 parts styrene and 70 parts butadiene, a copolymer of 43 parts styrene and 57 parts butadiene and a copolymer of 50 parts styrene and 50 parts butadiene; polymers and copolymers of conjugated dienes such as polybutadiene, polyisoprene, polychloroprene, and the like, and copolymers of such conjugated dienes with an ethylenic group-containing monomer copolymerizable therewith such as styrene, methyl styrene, chlorostyrene, acrylonitrile, 2-vinyl-pyridine, 5-methyl 2-vinylpyridine, 5-ethyl-2-vinylpyridine, 2-methyl -5-vinylpyridine, alkyl-substituted acrylates, vinyl ketone, methyl isopropenyl ketone, methyl vinyl either, alphamethylene carboxylic acids and the esters and amides thereof such as acrylic acid and dialkylacrylic acid amide; also suitable for use herein are copolymers of ethylene and other high alpha olefins such as propylene, butene-1 and pentene-1.

The elastomeric compounds of the present technology may be additionally compounded with one or more coupling agents to further enhance the properties of the elastomeric compound. Coupling agents, as used herein, include, but are not limited to, compounds that are capable of coupling fillers such as carbon black or silica to an elastomer. UsefUl coupling agents include, but are not limited to, silane coupling agents such as bis(3-triethoxysilylpropyl)tetrasulfane (Si-69), 3-thiocyanatopropyl-triethoxy silane (Si-264, from Degussa AG, Germany), γ-mercaptopropyl-trimethoxy silane (A189, from Union Carbide Corp., Danbury, Conn.); zirconate coupling agents, such as zirconium dineoalkanolatodi(3-mercapto) propionato-O (NZ 66A, from Kenrich Petrochemicals, Inc., of Bayonne, N.J.), titanate coupling agents; nitro coupling agents such as N,N′-bis(2-methyl-2-nitropropyl)-1,6-diaminohexane (Sumifine 1162, from Sumitomo Chemical Co., Japan); and mixtures of any of the foregoing. The coupling agents may be provided as a mixture with a suitable carrier, for example X50-S which is a mixture of Si-69 and N330 carbon black, available from Degussa AG.

In some embodiments, the elastomeric compositions of the present technology include, but are not limited to, vulcanized compositions (VR), thermoplastic vulcanizates (TPV), thermoplastic elastomers (TPE) and thermoplastic polyolefins (TPO). TPV, TPE, and TPO materials are further classified by their ability to be extruded and molded several times without loss of performance characteristics. The elastomeric compositions of the present technology can therefore contain an elastomer, curing agents, reinforcing filler, a coupling agent, and, optionally, various processing aids, oil extenders, and antidegradents. In addition to the examples mentioned above, the elastomer can be, but is not limited to, polymers (e.g., homopolymers, copolymers, and terpolymers) manufactured from 1,3 butadiene, styrene, isoprene, isobutylene, 2,3-dimethyl-1,3 butadiene, acrylonitrile, ethylene, propylene, and the like. It is preferred that these elastomers have a glass transition point (Tg), as measured by DSC, between ˜120° C., and 0° C. Examples of such elastomers include poly(butadiene), poly(styrene-co-butadiene), and poly(isoprene).

The elastomeric compositions may include one or more curing agents such as, for example, sulfur, sulfur donors, activators, accelerators, peroxides, and other systems used to effect vulcanization of the elastomer composition. The following patents provide examples of various ingredients, such as curing agents, elastomers, uses, and the like which can be used in the present invention: U.S. Pat. Nos. 6,573,324; 6,559,209; 6,518,350; 6,506,849; 6,489,389; 6,476,154; 6,878,768; 6,837,288; 6,815,473; 6,780,915; 6,767,945; 7,084,228; 7,019,063, and 6,984,689. Each of these patents is incorporated in their entirety by reference herein.

Conventional techniques that are well known to those skilled in the art can be used to prepare the elastomeric compositions and to incorporate the carbon black. The mixing of the rubber or elastomer compound can be accomplished by methods known to those having skill in the rubber mixing art. For example, the ingredients are typically mixed in at least two stages, namely at least one non-productive stage followed by a productive mix stage. The final curatives are typically mixed in the final stage which is conventionally called the “productive” mix stage in which the mixing typically occurs at a temperature, or ultimate temperature, lower than the mix temperature(s) of the preceding non-productive mix stage(s). The terms “non-productive” and “productive” mix stages are well known to those having skill in the rubber mixing art. Wet masterbatch methods for producing filled elastomeric compositions, such as those disclosed in U.S. Pat. Nos. 5,763,388, 6,048,923, 6,841,606, 6,646,028, 6,929,783, 7,101,922, and 7,105,595 may also be employed to produce elastomeric compositions containing carbon blacks according to various embodiments of the invention, and these patents are incorporated in their entirety by reference herein.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

### EXAMPLES

The examples below are given so as to illustrate the practice of various embodiments of the present disclosure. They are not intended to limit or define the entire scope of this disclosure. It should be appreciated that the disclosure is not limited to the particular embodiments described and illustrated herein but includes all modifications and variations falling within the scope of the disclosure as defined in the appended embodiments.

### Example 1—Recovering Carbon Black from Micronized Rubber

Monochloramine is produced through a chemical reaction between ammonia and chlorine. While there are several synthesis pathways, this technology uses a reaction of aqueous sodium hypochlorite and aqua ammonia in stochiometric quantities per the below reaction:

NaOCl+NH₃→NH₂Cl+NaOH

The aqueous monochloramine is reacted with micronized rubber having an average maximum particle size of 500 microns, in a reactor at an approximate mass fraction of between about 7-15%. The resulting aqueous liquid is then separated from the unreacted micronized rubber which can then be further reacted with additional aqueous monochloramine.

The aqueous solution separated from the micronized rubber in the previous step is then sent for processing. A two staged filtration process consisting of a 500 kDa ultrafiltration membrane and a 50 kDa ultrafiltration membrane system is used to separate the carbon black particulates from the rest of the aqueous solution which also contains devulcanized rubber. The filtration system then concentrates the liquid solution containing carbon black until the precipitation point is reached. After precipitating, the carbon black is centrifuged, dried, and packaged using conventional methods.

A composition (elastomeric composition or rubber matrix) comprising the recovered carbon black was measured to have an elongation % of 299.00, a tensile strength of 8.40 MPa, a drum abrasion of 52.2 ARI, and a tear strength die B of 44.8 kN/m.

### Example 2—Recovering Carbon Black from Zinc and Silica Impurities

Alternatively, carbon black produced through aqueous chloramine devulcanization, along with the zinc and silica impurities, leave the devulcanization reactor as a dilute slurry and are separated from devulcanized rubber via a filtration and centrifugation system. The centrifugation system accumulates the carbon black, silicon dioxide, and zinc oxide as a dense paste which is removed by batch from a solid bowl centrifuge. The paste, still wetted, is transferred from the centrifuge bowl into a batch reactor and mixed with an aqueous solution of sodium hydroxide. The solid to liquid ratio by mass is about 1-5% with the concentration of reactable inorganics (zinc oxide and silicon dioxide) in the range of about 0.05-0.15 mol/L. A stoichiometric amount of sodium hydroxide is added (about 0.05-0.15 mol/L) and the reaction mixture is heated to 100-250° C. at the autogenous pressure (about 1-35 bar) for between about 15 minutes and 6 hours. The reaction mixture is continuously mixed during the reaction. Solid-to-liquid ratio, concentration of sodium hydroxide, reaction temperature, and residence time may be adjusted to produce a more or less complete reactants conversion depending on the desired outcome. The completed reaction is drained from the reactor and allowed to cool in a holding tank before entering a filtration loop. The carbon black is separated from the dissolved impurities (e.g., sodium silicate and sodium zincate) via ceramic ultrafiltration membrane (membrane pores about 0.1 micron). The sodium silicate and sodium zincate containing ultrafiltration permeate is then processed to extract precipitated silica in accordance to methods that are standard to that art. The carbon black is cleaned via multiple steps of diafiltration using pure water. The cleaned carbon black is then centrifuged, and the cleaned carbon black paste is removed and sent to drying and packaging systems.

All references cited in this specification, and their references, are incorporated by reference herein in their entirety where appropriate for teachings of additional or alternative details, features, and/or technical background.

While the disclosure has been particularly shown and described with reference to particular embodiments, it will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for recovering carbon black (rCB) from a vulcanized polymer matrix, the method comprising performing oxidative desulfurization of the vulcanized polymer matrix with an aqueous chloramine solution.

2. The method of claim 1, wherein the vulcanized polymer matrix is a micronized vulcanized polymer matrix.

3. The method of claim 2, wherein the micronized vulcanized polymer matrix has an average particle size of less than about 500 microns.

4. The method of claim 2, wherein the micronized vulcanized polymer matrix has an average particle size of less than about 250 microns.

5. The method of any one of claims 1 to 4, wherein the vulcanized polymer matrix is a vulcanized copolymer matrix.

6. The method of claim 5, wherein the vulcanized copolymer matrix is a styrene-butadiene matrix.

7. The method of any one of claims 1 to 4, wherein the polymer matrix is rubber.

8. The method of claim 7, wherein the polymer matrix is a tire.

9. The method of any one of claims 1 to 8, wherein reacting the vulcanized polymer matrix with the aqueous chloramine solution selectively breaks sulfur crosslinks.

10. The method of any one of claims 1 to 9, wherein reacting the vulcanized polymer matrix with the aqueous chloramine solution facilitates opening up of the vulcanized polymer matrix and the release of the carbon black.

11. The method of claim 10, wherein the aqueous chloramine solution comprises chloramine in a concentration of between about 0.05 mol/L and about 1.0 mol/L, or between about 0.05 mol/L and about 0.5 mol/L, or between about 0.075 mol/L and about 0.3 mol/L.

12. The method of any one of claims 1 to 11, wherein the chloramine is monochloramine.

13. The method of any one of claims 1 to 11, wherein the chloramine is dichloramine.

14. The method of any one of claims 1 to 11, wherein the chloramine is trichloramine.

15. The method of any one of claims 1 to 14, wherein the step of reacting the polymer matrix with the aqueous chloramine solution comprises heating the reaction mixture at a temperature of less than about 250° C.

16. The method of any one of claims 1 to 14, wherein the step of reacting the polymer matrix with the aqueous chloramine solution comprises heating the reaction mixture at a temperature between about 50° C. and 90 ° C.

17. The method of any one of claims 1 to 16, wherein the step of reacting the polymer matrix with the aqueous chloramine solution is carried out for a period of between about 0.5 hour and about 48 hours.

18. The method of any one of claims 1 to 17, wherein the step of reacting the polymer matrix and the aqueous chloramine solution is performed at a pressure of at least about 10 psi, at least about 11 psi, at least about 12 psi, at least about 13 psi, or at least about 15 psi.

19. The method of any one of claims 1 to 17, wherein the step of reacting the polymer matrix and the aqueous chloramine solution is performed at a pressure of at least 14.69 psi.

20. The method of any one of claims 1 to 19, wherein the carbon black is recovered from the reaction mixture by filtration, centrifugation, straining, cycloning, flotation, skimming, or flocculation, or by a combination thereof.

21. The method of any one of claims 1 to 19, further comprising a step of separating the carbon black from impurities.

22. The method of claim 21, wherein the impurities include sodium silicate and sodium zincate.

23. A method for recovering carbon black from micronized rubber, the method comprising:
a) reacting the micronized rubber with an aqueous chloramine solution to obtain a first reaction mixture;
b) separating the first reaction mixture from unreacted micronized rubber to obtain a second reaction mixture; and
c) separating carbon black particulates from the second reaction mixture.

24. The method of claim 24, wherein the micronized rubber has an average particle size of less than about 500 microns.

25. The method of claim 23 or 34, wherein step a) results in selective breakage of sulfur crosslinks.

26. The method of claim 25, wherein step a) facilitates opening up of the polymer matrix and the release of the carbon black.

27. The method of any one of claims 23 to 26, wherein the aqueous chloramine solution comprises chloramine in a concentration of between about 0.05 mol/L and about 1.0 mol/L, or between about 0.05 mol/L and about 0.5 mol/L, or between about 0.075 mol/L and about 0.3 mol/L.

28. The method of any one of claims 23 to 27, wherein the chloramine is monochloramine.

29. The method of any one of claims 23 to 27, wherein the chloramine is dichloramine.

30. The method of any one of claims 23 to 27, wherein the chloramine is trichloramine.

31. The method of any one of claims 23 to 30, wherein step a) further comprises heating the the micronized rubber with the aqueous chloramine solution at a temperature of less than about 250° C.

32. The method of any one of claims 23 to 30, wherein step a) further comprises heating the the micronized rubber with the aqueous chloramine solution at a temperature between about 50° C. and 90° C.

33. The method of any one of claims 23 to 32, wherein step a) is carried out for a period of between about 0.5 hour and about 48 hours.

34. The method of any one of claims 23 to 33, wherein step a) is performed at a pressure of at least about 10 psi, at least about 11 psi, at least about 12 psi, at least about 13 psi, or at least about 15 psi.

35. The method of any one of claims 23 to 34, wherein step a) is performed at a pressure of at least 14.69 psi.

36. The method of any one of claims 23 to 35, wherein step c) is performed using filtration, centrifugation, straining, cycloning, flotation, skimming, or flocculation, or a combination thereof.

37. A carbon black composition obtained by the method as defined in any one of claims 1 to 36.

38. An elastomeric composition or rubber matrix comprising at least one carbon black obtained by the method as defined in any one of claims 1 to 36.

39. A tire or part thereof comprising the elastomeric composition or rubber matrix of claim 38.
